(19) United States
(12) Patent Application Publication
(10) Pub. No.: US 2013/0322664 A1
(43) Pub. Date: Dec. 5, 2013

(54) NOISE ELIMINATION CIRCUIT FOR AUDIO EQUIPMENT

(71) Applicants: HONG FU JIN PRECISION INDUSTRY (WUHAN) CO., LTD., Wuhan (CN); HON HAI PRECISION INDUSTRY CO., LTD., New Taipei (TW)

(72) Inventor: LI-YONG WANG, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 13/741,525

(22) Filed: Jan. 15, 2013

(30) Foreign Application Priority Data
May 29, 2012 (CN) 201210170698.2

(51) Int. Cl. H04R 3/02

(52) U.S. Cl. CPC H04R 3/02
USPC 381/300; 381/94.5

(57) ABSTRACT

A noise elimination circuit, includes an audio chipset configured to process an audio data file, a power supply unit, a loudspeaker, and a ground circuit. The power supply unit is connected to the sound card and provides power to the audio data file. The audio chipset generates an analog signal when the power supply unit stops providing power to the audio data file. The loudspeaker is connected to the audio chipset via a transmission line. The ground circuit is connected to the transmission line. The ground circuit is turned on to transmit the analog signal to ground when power supply unit stops providing power to the audio data file.

### BACKGROUND

1. Technical Field

The present disclosure relates to noise elimination circuits, more particularly to a noise elimination circuit for eliminating the noise of an audio equipment.

2. Description of Related Art

Multimedia audio equipment generally includes a sound card disposed on a motherboard and an audio output device such as a loudspeaker. The sound card and the audio output device are mounted in an electronic device which needs to output sound. However, when the electronic device is shut down, the sound card usually generates an analog output. The analog output is transmitted to the loudspeaker to have the loudspeaker generate noise.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of a noise elimination circuit in accordance with one embodiment of the present disclosure.

FIG. 2 is a circuit diagram of the noise elimination circuit of FIG. 1.

FIG. 3 is a block diagram of a noise elimination circuit in accordance with another embodiment of the present disclosure.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

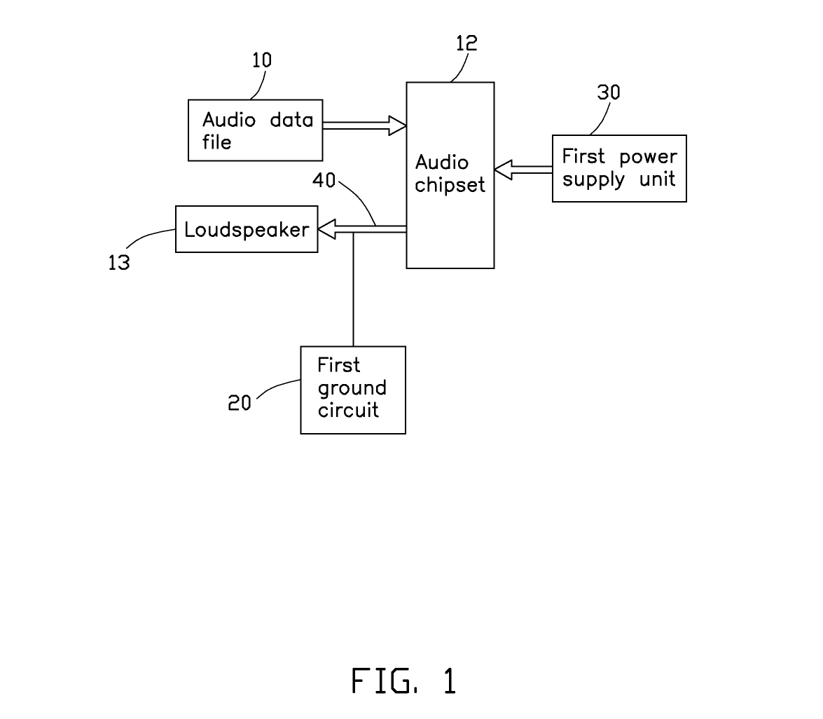

FIG. 1 is a noise elimination circuit in accordance with one embodiment. The noise elimination circuit is used to process an audio data file 10. The noise elimination circuit includes an audio chipset 12, a loudspeaker 13, a first ground circuit 20, and a first power supply unit 30. The audio data file 10 is transmitted to the audio chipset 12. The audio chipset 12 processes the audio data file 10 to generate an audio signal which is sent to the loudspeaker 13. The loudspeaker 13 is connected to the audio chipset 12 via a transmission line 40. The first ground circuit 20 is connected to the transmission line 40. The first power supply unit 30 is connected to the audio chipset 12.

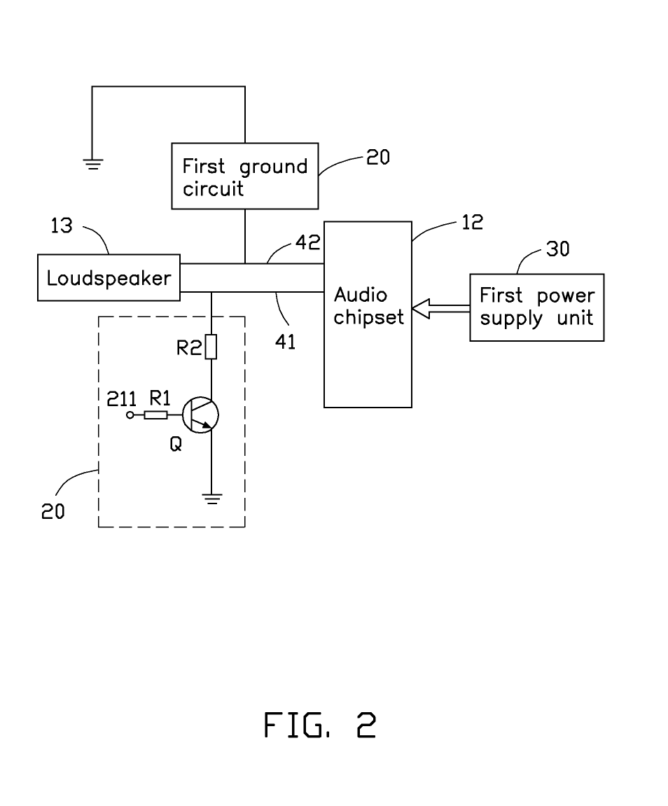

FIG. 2 shows that the transmission line 40 includes a left sound channel line 41 and a right sound channel line 42. The first ground circuit 20 connects the left sound channel line 41 and the right sound channel line 42 to ground. The first ground circuit 20 includes a control end 211 and a transistor Q. In one embodiment, the transistor Q is an NPN type transistor.

The control end 211 is connected to a base electrode of the transistor Q via a first resistor R1. A collector electrode of the transistor Q is connected to the left sound channel line 41 or the second channel line 42 via a second resistor R2. The emitter electrode of the transistor Q is connected to ground. The control end 211 receives a power on signal PSON output from the first power supply unit 30. When the first power supply unit 30 supplies power to the audio chipset 12, the power on signal PSON is at a low level. When the first power supply unit 30 stops supplying power to the audio chipset 12, the power on signal PSON is at a high level.

In work, the first power supply unit 30 supplies power to the audio chipset 12. The power on signal PSON is at a low level to turn off the transistor Q. The left sound channel line 41 and the right sound channel line 42 outputs the audio signal to the loudspeaker 13 from the audio chipset 12.

When the first power supply unit 30 stops supplying power to the audio chipset 12, an analog signal is generated in the audio chipset 12 and the power on signal PSON is at a high level to turn on the transistor Q. The left sound channel line 41 and the right sound channel line 42 connect to ground via the transistor Q. Therefore, the analog signal is transmitted to ground and not transmitted to the loudspeaker 13 to avoid generating noise.

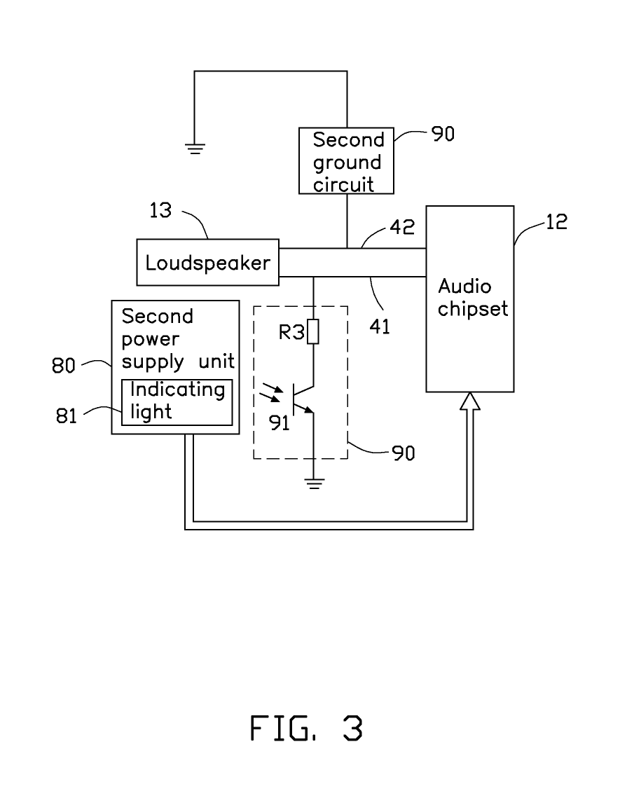

FIG. 3 shows that in another embodiment of the noise elimination circuit, a second power supply unit 80 and a second ground circuit 90 is used. The second power supply unit 80 includes an indicating light 81. When the second power supply unit 80 supplies power, the indicating light 81 does not light up. When the second power supply unit 80 does not supplies power, the indicating light 81 lights up. The second ground circuit 90 includes a photocoupler 91 which is located adjacent to the indicating light 81. The photocoupler 91 is controlled by the indicating light 81. An end of the photocoupler 91 is connected to the left sound channel line 41 or the right sound channel line 42 via a third resistor R3. Another end of the photocoupler 91 is connected to ground.

In operation, the second power supply unit 80 supplies power to the audio chipset 12, the indicating light 81 does not light up, the photocoupler 91 is off, and the left sound channel line 41 and the right sound channel line 42 outputs audio signals to the loudspeaker 13 from the audio chipset 12.

When the second power supply unit 80 stops supplying power to the audio chipset 12, the analog signal is generated in the audio chipset 12 and the indicating light 81 lights up to turn on the photocoupler 91. The left sound channel line 41 and the right sound channel line 42 connect to ground via the photocoupler 91. Therefore, the analog signal is transmitted to ground and not transmitted to the loudspeaker 13 to avoid generating noise.

It is to be understood, however, that even though numerous characteristics and advantages of the embodiments have been set forth in the foregoing description, together with details of the structure and functions of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A noise elimination circuit, comprising:
an audio chipset configured to process an audio data file;
a power supply unit connected to the audio chipset and configured to provide power to the audio chipset, the audio chipset configured to generate an analog signal when the power supply unit stops providing power to the audio chipset;
a loudspeaker connected to the audio chipset via a transmission line; and
a ground circuit connected to the transmission line, wherein the ground circuit is configured to be turned on to transmit the analog signal to ground when the power supply unit stops providing power to the audio chipset.

2. The noise elimination circuit of claim 1, wherein the ground circuit comprises an NPN type transistor, a base electrode of the NPN type transistor receives a power on signal outputted from the power supply unit, and the power on signal is at a low level when the power supply unit supplies power to the audio chipset and at a high level when the power supply unit stops supplying power to the audio chipset.

3. The noise elimination circuit of claim 2, wherein a collector electrode of the NPN type transistor is connected to the transmission line, and an emitter electrode of the NPN type transistor is connected to ground.

4. The noise elimination circuit of claim 3, wherein the transmission line comprises a left sound channel line and a right sound channel line, and both of the left sound channel line and the right sound channel line are connected to ground via the ground circuit.

5. The noise elimination circuit of claim 1, wherein the power supply unit comprises an indicating light, and the ground circuit comprises a photocoupler which is controlled by the indicating light.

6. The noise elimination circuit of claim 5, wherein a first end of the photocoupler is connected to the transmission line, and a second end of the photocoupler is connected to ground.

7. The noise elimination circuit of claim 6, wherein the indicating light is configured to light up when the power supply unit does not supply power to the audio chipset to turn on the photocoupler, and the indicating light is configured not to light up when the power supply unit supplies power to the audio chipset to turn off the photocoupler.

8. A noise elimination circuit, comprising:
an audio chipset for receiving an audio data file and transforming the audio data file to an audio signal;
a loudspeaker connected to the audio chipset for receiving the audio signal for audible output;
a ground circuit connected to the audio chipset; and
a power supply unit having a first terminal for providing power to the audio chipset and a second terminal outputting a control signal for controlling the ground circuit to be switched on or cut off.

9. The noise elimination circuit of claim 8, wherein the ground circuit comprises an NPN type transistor, a base electrode of the NPN type transistor is connected to a power on signal outputted by the second terminal, and the power on signal is at a low level when the power supply unit supplies power the audio chipset and at a high level when the power supply unit stops supplying power to the audio chipset.

10. The noise elimination circuit of claim 9, wherein a collector electrode of the NPN type transistor is connected to the audio chipset, and an emitter electrode of the NPN type transistor is connected to ground.

11. The noise elimination circuit of claim 10, wherein the transmission line comprises a left sound channel line and a right sound channel line, and both of the left sound channel line and the right sound channel line are connected to ground via the ground circuit.

12. The noise elimination circuit of claim 8, wherein the power supply unit comprises an indicating light, and the ground circuit comprises a photocoupler which is controlled by the indicating light.

13. The noise elimination circuit of claim 12, wherein a first end of the photocoupler is connected to the audio chipset, and a second end of the photocoupler is connected to ground.

14. The noise elimination circuit of claim 13, wherein the indicating light is configured to light up when the power supply unit does not supply power to the audio chipset to turn on the photocoupler, and the indicating light is configured not to light when the power supply unit supplies power to the audio chipset to turn off the photocoupler.
